(19) United States
(12) Patent Application Publication
(10) Pub. No.: US 2026/0237839 A1
(43) Pub. Date: Aug. 13, 2026

(54) GAS OUTLET PLATE FOR BATTERY MODULES

(71) Applicant: Oerlikon Friction Systems (Germany) GMBH, Bremen (DE)

(72) Inventors: Heribert Walter, Gottingen (DE); Michael Maag, Herrieden (DE); Tobias Fritz, Seukendorf (DE); Jessica Rumpf, Bubenreuth (DE)

(73) Assignee: Oerlikon Friction Systems (Germany) GMBH, Bremen (DE)

(21) Appl. No.: 19/152,885

(22) PCT Filed: Jan. 30, 2024
(86) PCT No.: PCT/EP2024/052204

§ 371 Date: Jul. 31, 2025

(30) Foreign Application Priority Data
Feb. 3, 2023 (DE) 102023102698.4

(51) Int. Cl. H01M 50/383; H01M 50/209; H01M 50/271

(52) U.S. Cl. CPC H01M 50/383; H01M 50/209; H01M 50/271

(57) ABSTRACT

The present invention relates to a gas outlet plate (1) having gas outlet flaps (3) with adjustable pressure release as a safety device for a battery module in the event of thermal runaway of a battery cell (6) for discharging the hot gas flow from the cell region of the module, wherein the gas outlet plate (1) has a base plate (2) which is composed of a high temperature-resistant material and in which an arrangement of adjustable gas outlet flaps (3) is inserted, wherein the gas outlet flaps (3) have a free circumference (4), which defines the foldable region, and a bending edge (5), via which the gas outlet flaps (3) are connected to the base plate (2), and open when struck by a hot gas flow, and to the use of the gas outlet plate (1) for producing a battery module, and to a battery module having a gas outlet plate (1).

The present invention relates to a gas outlet plate as a safety device for battery modules, which, in the event of a thermal runaway of a battery cell of the module, ensures the safe discharge of a hot gas, which is also enriched with conductive particles, and which is emitted from the battery cell, in order to prevent it from spreading to neighboring cells and causing a short circuit with the formation of an arc between the battery housing material and the current-carrying components.

Furthermore, the present invention relates to a battery module having a gas outlet plate according to the invention and to the use of a gas outlet plate according to the invention for battery modules.

For vehicles having an electric drive, rechargeable battery systems are used, whereby lithium-ion battery cells are particularly used these days. Two or more cells are arranged in rows as closely as possible to form a module in a battery cell or module housing and are electrically connected. Several battery modules are in turn assembled and also electrically connected to form a battery pack.

These battery systems must have very high energy densities for operation in vehicles, but these high densities also pose a high safety risk. Safe operation of these battery systems is only possible up to a comparatively low critical temperature. Oxidation processes between electrolyte components and battery cell electrode components begin at temperatures as low as approximately 80° C., leading to progressive heating of the cell and eventual cell damage, even leading to thermal runaway.

A progressive heat increase in the cell leads to a gas formation which, with increasing gas pressure, can lead to the explosion of the cell, whereby an easily inflammable gas escapes from the cell at high pressure, which usually ignites immediately upon contact with air and reaches very high temperatures. This very hot gas also carries with it conductive particles, such as graphitic carbon, metallic particles, and other decomposition products of the cell contents.

In order to be able to reduce the increase in cell pressure caused by gas formation, battery cells can be equipped with degassing vents such as a safety valve or a bursting membrane through which the gas can escape into the surrounding area of the battery cell.

However, even in this case, for reasons of operational safety of the battery cells and, in particular, also the safety of any vehicle occupants, it must be ensured that an energy transfer to neighboring cells and modules is avoided in order to prevent the spread of thermal runaway or at least to prevent it for as long as possible.

In particular, a short circuit between the current-carrying components and the battery pack material caused by the gas charged with conductive particles and the formation of an arc, which can have temperatures of up to several thousand degrees Celsius, must be avoided.

For reasons of operational safety and for the protection of the vehicle occupants, a suitable protective concept for a battery pack must ensure that after detecting the first signs of a thermal runaway of a battery cell, no sparks or flames appear outside the battery pack, i.e., become visible, for a period of several minutes. To meet safety standards, this period until flames become visible outside the battery pack should preferably be no shorter than 5 minutes.

This is where the present invention can be used. The present invention relates to a gas outlet plate with adjustable gas outlet flaps having the features of claim 1.

The dependent claims relate to preferred embodiments.

Furthermore, the present invention relates to a battery cell module having a gas outlet plate according to the invention with adjustable gas outlet flaps and a module housing having a gas outlet plate with adjustable gas outlet flaps, as well as to the use of a gas outlet plate according to the invention with adjustable gas outlet flaps for a battery module or module housing.

The gas outlet plate according to the invention with adjustable gas outlet flaps is formed from a base plate having high-temperature resistance as well as gas outlet flaps which are designed to open at a predetermined gas pressure and to discharge gas from the interior of a battery module.

In the context of the present invention, “adjustable gas outlet flap” means that the gas outlet flap is only actuated when a predetermined pressure is applied.

A battery cell that underwent thermal runaway is also referred to as a propagating battery cell.

The gas outlet flaps are partially cut areas in the base plate, with part of the circumference of the area detached from the base plate. This part is referred to here as the “free circumference.” Only the remaining part of the circumference is connected to the base plate. This connected part is referred to here as the “bending edge”.

The free circumference may be separated from the base plate through the entire thickness of the base plate, and partial separation is also possible, for example, the separation of the thickness of the base plate does not completely pass through the base plate, or the base plate may have a perforation along the free circumference.

The shape of the gas outlet flaps can be selected according to requirement. It can be round, oval, or square. It should be sufficiently large so that the incoming gas flow is safely and completely discharged.

During normal operation, the base plate and gas outlet flaps essentially form a flat surface. If the pressure acting on a gas outlet flap exceeds a predetermined value due to gas escaping from a battery cell, the gas outlet flap yields to the pressure and flaps open along the bending edge, diverting the gas flow from the propagating battery cell.

The gas outlet plate according to the invention enables the rapid and direct discharge of a hot gas flow containing conductive particles from an overheated cell of a module out from the battery module, without causing a short circuit or arcing between current-carrying components and the battery pack material. A spreading to neighboring battery cells and the appearance of visible flames outside the battery pack can thus be prevented, in accordance with safety regulations, for a sufficiently long period of at least 5 minutes, and in particular at least 7 minutes or longer.

With regard to establishing the object of the invention, the gas outlet plate with gas outlet flaps according to the invention is made of a high-temperature-resistant material so that safe gas discharge can be ensured without the plate itself catching fire or becoming deformed due to the thermal effect.

Preferably, the gas outlet plate is formed from a layered structure of high-temperature-resistant fiber composite material, wherein particularly high-temperature-resistant fibers will be used for the layers.

The gas outlet plate according to the invention can be similarly used for modules made of prismatic cells, cylindrical cells (round battery cells) or pouch cells.

Due to its design, the gas outlet plate according to the invention can absorb mechanical loads that arise during assembly of the battery cells, so that it can also be used as a structural component for the module housing.

For example, the gas outlet plate according to the invention with adjustable gas outlet flaps can be integrated into a module housing depending on the position of the degassing vents in the outer surface of the battery cells.

For example, if the degassing vents are located on the top side of the battery cells of a battery cell arrangement, the gas outlet plate according to the invention can be designed as a cover of the module housing. If the degassing vents are positioned on the bottom surface of the battery cells, the gas outlet plate can form the mounting surface or the bottom surface of the module housing.

The gas outlet plate can also be installed as a component into the module between the region containing the battery cell vents and the module housing wall.

If it is necessary to discharge a gas flow from a propagating battery cell as quickly as possible from the danger zone, the respective gas outlet flaps should be positioned close to the battery cell degassing vents to ensure that the gas outlet flaps can open as quickly as possible when the temperature and pressure loads are combined. The gas outlet flaps of the non-propagating battery cells must remain closed to prevent contact between the non-propagating battery cells and the electrically conductive particles in the gas in these regions.

Usually, one gas outlet flap in the gas outlet plate is assigned to each battery cell of a module. If required, very large battery cells with more than one degassing vent can have two or more gas outlet flaps. Depending on the specific application, it is also possible that there are fewer gas outlet flaps than battery cells.

For example, according to one embodiment, for a module of battery cells with degassing vents in the bottom surface, the gas outlet plate can serve as a mounting surface for the battery cells and, at the same time, as the base plate of the module, wherein the gas outlet plate can have a gas outlet flap for each battery cell. The circumferential shape of the gas outlet flaps can be appropriately matched to the shape of the bottom surface of the battery cell, for example, essentially circular in the case of a round cell or rectangular in the case of a prismatic cell.

In general, the gas outlet flap area is smaller than the bottom area of the battery cell, but at least large enough to fully cover the degassing vents and consequently the gas flow that may be discharged.

An essential feature of the present invention is the determination and adjustment of the opening pressure of the gas outlet flaps. The opening pressure must be adjusted to the actuating pressure of the battery cell degassing vents. In particular, it must be sufficiently low to ensure rapid and safe discharge of the gas flow from a propagating battery cell.

If the opening pressure is too high, when necessary, the flap will only open with a delay or it will not open at all. If it is too low, there is a risk that the gas outlet flap will open prematurely, e.g., due to external influences during module manufacturing, or it is also possible that the pressure of the gas escaping from a cell may cause neighboring gas outlet flaps to open, posing a risk of contamination of neighboring cells with electrically conductive particles in the gas flow.

The degassing vents of commercially available lithium-ion battery cells typically open at a pressure between 0.4 and 13 bars. The pressure at which the opening occurs is influenced by numerous factors, such as cell size, cell chemistry, charging level, cell geometry, the design of the battery cell's degassing vents, and the basic cell design.

Corresponding to these requirements, according to the invention, the opening pressure of the gas outlet flaps is precisely adjusted, with the opening pressure being influenced in particular by the length of the bending edge and the thickness of the base plate, as well as the area of the gas outlet flap loaded with gas and the material composition of the base plate.

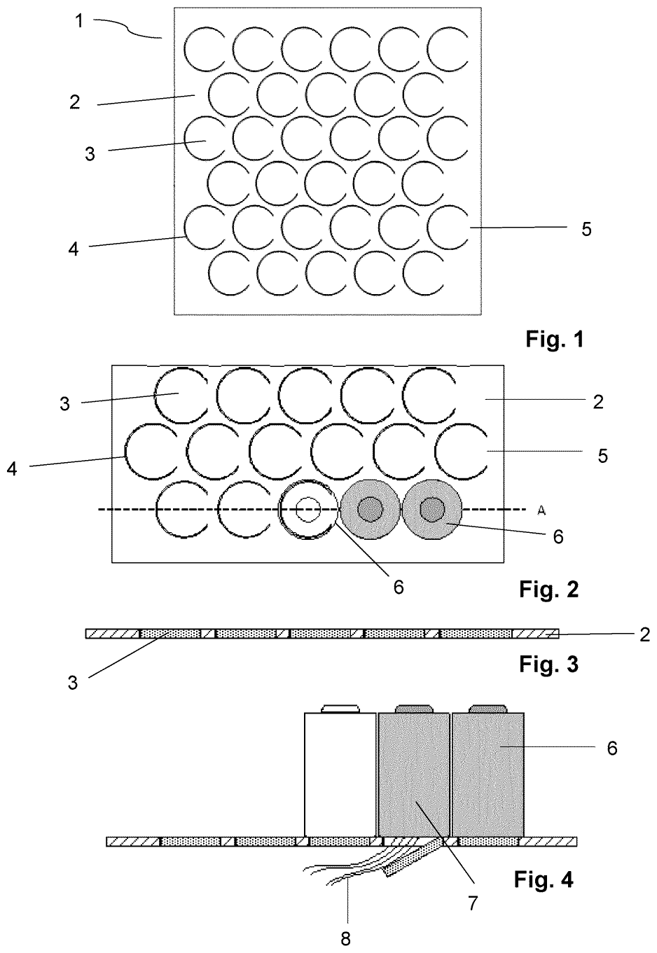

In the case of a gas outlet flap with a circular outline, the length of the bending edge is the distance between the two endpoints of the circular segment that represents the flap area, i.e. the free circumference defines a circular segment that forms the flap area, for example, as shown below in FIG. 1.

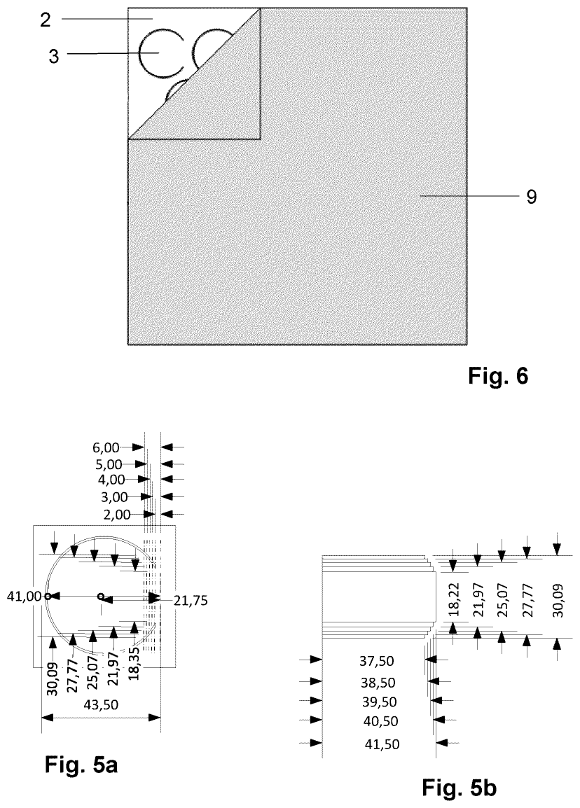

To determine and adjust a defined opening pressure for a gas outlet plate with gas outlet flaps according to the invention, particularly for designing the dimensions, including the geometry of the bending edge and the length, a simple test was developed using a bending strip and a weight, wherein the bending strip is made of the same material used for a gas outlet plate and has the same thickness. The test is explained below with reference to FIG. 5 using the example of a gas outlet flap with a circular base shape.

With a circular diameter of 43.5 mm, proceeding from an actuating pressure of a degassing vent opening of 0.04 bar, a pressure of 0.04 MPa acts on the circular surface acts on the circular area, which corresponds to a force of 59.4 N and thus a weight of 6 kg.

The determination of the opening pressure can be carried out based on this, for example, using a balance such as a spring balance, on appropriately manufactured bending strips, whereby the weight at which a bending strip of a specified width, which corresponding to a bending edge, and a length corresponding to the extension of the foldable area of the flap, bends from the bending edge to the end facing the free circumference.

Similarly, the test can be used to determine and set the actuating pressure for gas outlet valves with a base shape other than circular.

The gas outlet plate according to the invention is made of a high-temperature-resistant material to ensure safe discharge of the hot gas without the gas outlet plate itself catching fire or deforming due to thermal effects. The gas outlet plate expediently has a temperature resistance of at least 600° C., and preferably higher, up to at least 1400° C., and is itself electrically non-conductive.

The gas outlet plate preferably has a layered structure of fiber composite layers. High-temperature-resistant fibers are used for the fiber composite layers. Particularly, mineral fibers, such as basalt fibers, glass fibers, silicate fibers, and oxide-ceramic fibers, can be used.

The fibers may be in the form of a fabric such as a woven fabric or non-crimp fabric, whereby the fabrics themselves may be made from rovings or yarns made out of these fibers.

According to one embodiment, the fiber orientation can be bidirectional, e.g., in particular 0°/90°. However, the fiber orientation can vary as required, e.g., it can also be multidirectional, such as 0°/90°/45°, etc.

The plastics used as matrix materials also exhibit high temperature resistance. Examples include silicone resins, especially silicone resins with a high SiO content, particularly an SiO content of 50 to 90%, and particularly preferred is 75% and higher.

Silicone resins with a SiO content of at least 80% have proven particularly suitable. According to one embodiment, silicone/phenolic resin mixtures, silicone/epoxy mixtures, or other suitable resin mixtures can be used to improve or for configuring the properties.

As silicone resin, di- and/or trifunctional polysiloxanes can be used, preferably with methyl and/or phenyl substituents.

An example of a suitable silicone resin is a methylsilicone resin, which is sold under the trademark SILRES® MK, which is marketed by the Wacker company.

The individual layers of the gas outlet plate can have different fibers and/or different fiber orientations.

For example, a layered structure can be composed of one or two cover layers made of a first fiber composite material as needed or more intermediate layers made of a second fiber composite material. The layers of different fiber composite materials can be arranged alternately.

The thickness of the individual layers should be as thick as required, but as thin as possible.

The overall thickness of the gas outlet plate should be as small as possible to achieve the desired space saving; preferably, the total thickness should not exceed 1.5 mm. A thickness of 1 mm or less is preferred to accommodate the desired compact, space-saving design of battery assemblies.

Preferably, the thickness selected should be such that the gas outlet plate has sufficient mechanical stability, for example, to support the battery cells until the battery assembly has been encased, for example, with a sealing foam. If necessary, a support film can also be used, as described in more detail below.

According to one embodiment, a thin film can be applied to the side of the gas outlet plate facing away from the battery cells. This film serves to mechanically stabilize the gas outlet plate and prevent premature opening of the gas outlet flaps due to the application of force when the module is being fabricated.

For example, depending on the application, the spaces between the connected battery cells can be filled with an expanding foam mass for stability and electrical insulation. The resulting expansion pressure can be sufficient to force open the gas outlet flaps. According to one embodiment of the invention, the film prevents unintentional premature opening.

In addition, the film seals the dividing line along the free circumference between the gas outlet flaps and the base plate, so that no moisture can penetrate.

Suitable films must have low tear strength and low elongation at break to ensure that they fail quickly under pressure if necessary, allowing the gas outlet flaps to open safely. A low melting point of the films is also advantageous, as the opening of the gas outlet flaps is thermally supported by melting the film.

Self-adhesive films are particularly advantageous because they can be applied without much effort.

Examples of suitable self-adhesive films are the electrical adhesive tapes from the SynFlex company, which are marketed under the product name SynTape ®. SynTape ® F/X.50, with its aramid paper backing and acrylate-based adhesive, is particularly suitable in terms of small thickness, tensile strength, and elongation at break, as well as a total thickness of 0.05 mm, a tensile strength of 35 N/10 mm, and an elongation at break of 5%. However, it is understood that films with different thicknesses and different values for tensile strength and elongation at break can be used depending on the requirements of the specific application.

The present invention will be explained in more detail below using an example of a gas outlet plate for round battery cells with reference to the attached figures, which show a design for an application of the gas outlet plate according to the invention with adjustable gas outlet flaps.

Shown are:

FIG. 1 shows a top view onto a gas outlet plate according to the invention with an arrangement of adjustable gas outlet flaps in the region of the mounting surfaces for battery cells,

FIG. 2 shows a top view onto a gas outlet plate according to the invention with adjustable gas outlet flaps,

FIG. 3 shows a lengthwise section along line A according to FIG. 2;

FIG. 4 shows a lengthwise section along line A according to FIG. 2 with round battery cells;

FIGS. 5a and 5b show a schematic representation for the determination of the length of a bending edge and the bending strip test for determining the release pressure; and

FIG. 6 shows a top view onto the underside of the gas outlet plate according to FIG. 1 with the protective film.

FIG. 1 shows a top view onto a gas outlet plate 1 according to the invention with base plate 2 and an arrangement of adjustable gas outlet flaps 3 for an arrangement of round battery cells. The arrangement has a hexagonal symmetry to achieve the densest possible packing for the round battery cells. It is self-evident that, in principle, any other suitable arrangement is also possible.

In the embodiment shown here, the gas outlet flaps 3 essentially have a circular shape with a free circumference 4 that describes a circular arc, wherein the connecting line between the two end points of the free circumference 4 defines the bending edge 5 of the gas outlet flap 3, along which the gas outlet flap 3 folds out when required.

The gas outlet flaps 3 are oriented in the same direction, with the bending edges 5 aligned parallel to each other.

However, the alignment of the bending edges 5 and the orientation of the gas outlet flaps can be selected according to the requirements of the individual application.

In the figure, each gas outlet flap 3 corresponds to a mounting surface for a round cell (not shown).

FIG. 2 shows a top view onto a gas outlet plate similar to FIG. 1, wherein round battery cells 6 are indicated in the bottom row of the figure on the three gas outlet flaps 3 on the right. The bottom surface of the round battery cells 6 has a slightly larger diameter than the gas outlet flaps 3, as indicated in the center illustration of the gas outlet flaps 3 with round cell 6, and completely covers the gas outlet flaps 3.

FIGS. 3 and 4 show a lengthwise section through the lower row of gas outlet flaps 3 along line A in FIG. 2. In this case, FIG. 3 shows the section without round battery cells 6 and FIG. 4 with round battery cells 6.

In FIG. 3, all gas outlet flaps 3 in the row are closed, and base plate 2 and gas outlet flaps 3 form a plane. FIG. 4 shows a failure scenario with a propagating battery cell 7, in which a hot gas flow 8 exits through a degassing vent in the bottom of the round cell 7, and the pressure of the gas flow 8 opens the underlying gas outlet flap 3. The gas flow 8 is discharged through the open gas outlet flap 3 from the mounting region of the battery cells 7, for example, from a module housing. Since the gas outlet flaps 3 of the non-propagating battery cells remain closed, no contact occurs between the gas flow 8, and, in particular, the electrically conductive particles contained in the gas flow 8, and the battery cells or other electrically conductive components, thus reliably preventing the thermal runaway of the propagating battery cell 7 from spreading to other cells 6, and in particular, a short circuit and the formation of an arc.

FIGS. 5a and 5b schematically show the determination and adjustment of the opening pressure of the adjustable gas outlet flaps 3 according to the invention using the example of gas outlet flaps 3 with a circular base shape.

The foldable part of the gas outlet flap 3 is a circular segment or circular section of a circle with diameter d (43.50 mm in the figure). The free circumference 4, i.e., the region separated from the base plate 1, or at least partially separated, defines a circular arc, with the bending edge 5 being the connecting line between the end points of the circular arc, i.e., the chord of the circle.

In other words, and as expressed in FIG. 5a, the length of the bending edge 5 results from the distance of the end points of the circular arc defined by the free circumference 4 to the tangent that lies at the full diameter of the circle and is closest to the bending edge (in the figure, on the right). The length of the bending edge is the distance between the two intersection points with the tangent. The maximum extent of the foldable region is the distance between bending edge and the tangent at the full diameter of the free circumference 4 (in the figure on the left).

In FIG. 5b, the situation from FIG. 5a is transferred to a bending strip test in order to determine the pressure at which a bending edge of a specified length bends and thus opens in the case of a gas outlet flap according to FIG. 5a for a given material composition.

Different widths for the bending edge are indicated horizontally in FIG. 5b, and the corresponding distance of the bending edge from the tangent at the free circumference 4 is shown vertically. This gives a measure for the remaining area, in this case circular area, which can open because of the gas pressure.

FIG. 6 shows a gas outlet plate 1 with adjustable gas outlet flaps 3 having a film 9 applied thereto, wherein the film 9 is applied to the side of the gas outlet plate 1 facing the side with battery cells. The film 9 serves particularly to seal and prevent moisture from entering the battery side. It can therefore be designed to be very thin. Furthermore, the film 9 can also aid in mechanical stability.

To ensure that the film 9 does not obstruct the opening of the respective gas outlet flaps 3 in the event of a battery cell failure, it should have low elongation at break and low tear strength. It should preferably tear as quickly as possible upon application of pressure, with as little stretching as possible.

### EXAMPLE

A gas outlet plate according to the invention with gas outlet flaps for round battery cells was manufactured, with the opening load of the gas outlet flaps set to 6 kg.

The gas outlet plate was composed of a four-layer fiber composite material with an upper and lower cover layer made of a composite of a basalt fabric with a surface weight of 420 g/m² and two intermediate layers of silica fabric with a surface weight of 300 g/m² . The matrix material was a silicone resin, SILRES® MK from the Wacker company.

The total thickness of the gas outlet plate was 1.3 mm. The thickness of the basalt fiber composite layers was 0.35 mm each, and the thickness of the silicate fiber composite layers was 0.3 mm each.

Gas outlet flaps were incorporated into the fiber-reinforced composite base plate, shaped like a segment of a circle with a diameter of 43.5 cm and a chord having a length of 39 mm, forming the bending edge.

A bending strip test corresponding to FIG. 5b demonstrated that the gas outlet flap thus formed opened reliably under a load of 6 kg.

### LIST OF REFERENCE NUMBERS

1 Gas outlet plate
2 Base plate
3 Gas outlet flap
4 Free circumference
5 Bending edge
6 Round battery cell
7 Propagating round battery cell
8 Gas flow
9 Film

1. A gas outlet plate (1) having adjustable gas outlet flaps (3) for discharging a hot gas flow (8) exiting from a degassing vent of a propagating battery cell (7) from the cell region of the battery module, wherein the gas outlet plate (1) comprises a base plate (2) into which an arrangement of adjustable gas outlet flaps (3) is inserted,
wherein the base plate (2) is made of a high-temperature-resistant material with a temperature resistance of at least 600° C.,
wherein the gas outlet flaps (3) have a free circumference (4) defining the foldable region and a bending edge (5) via which the gas outlet flaps (3) are connected to the base plate (2),
wherein the adjustable gas outlet flaps (3) are designed to open under pressure loading upon impact of a gas flow (8) and to discharge the gas flow (8) from the cell region of the battery module.

2. The gas outlet plate (1) with adjustable gas outlet flaps (3) according to claim 1, wherein the basic shape of the gas outlet flaps (3) is round, oval, or rectangular.

3. The gas outlet plate (1) according to claim 1, wherein the gas outlet plate (1) is designed as a mounting section for battery cells with a degassing vent in the bottom surface for a battery module.

4. The gas outlet plate (1) according to claim 1, wherein each battery cell (6) is matched with at least one gas outlet flap (3).

5. The gas outlet plate (1) according to claim 1, wherein on the side of the gas outlet plate (1) facing away from the battery cell arrangement, a film (9) is applied, which is designed to tear when a gas outlet flap (3) is opened.

6. Use of a gas outlet plate (1) with an adjustable gas outlet flap (3) according to claim 1, as a safety device for a battery module.

7. Use according to claim 6, wherein the gas outlet plate (1) is a component of the housing wall of the battery module and is arranged on the side of the housing which, in the finished state, is facing the degassing vents of the battery cells.

8. A battery module with a gas outlet plate (1) with adjustable gas outlet flaps (3) according to claim 1,
wherein the battery module comprises an arrangement of at least two battery cells (6) with degassing vents and a housing for accommodating the battery cells (6),
wherein the gas outlet plate (1) with gas outlet flaps (3) is arranged lying opposite the degassing vents of the battery cells (6).

9. The battery module according to claim 8, wherein the gas outlet plate (1) forms the bottom surface or the covering surface or the cover of a battery module.

10. The battery module according to claim 8, with battery cells (6) selected from cylindrical or prismatic cells or pouch cells.

11. The battery module according to claim 8, for battery cells (6) with degassing vents in the bottom surface, wherein the gas outlet plate (1) forms the mounting surface for the battery cells (6).
